(19) United States
(12) Patent Application Publication
(10) Pub. No.: US 2020/0378063 A1
(43) Pub. Date: Dec. 3, 2020

(54) METHOD OF MANUFACTURING FABRIC WITH EMBOSSED COATING LAYER, AND FABRIC PRODUCED THEREBY

(71) Applicants: Gwang Seok Song, Gimhae-Si (KR); Gwang Rae Cho, Busan (KR); HI-CO., LTD., Gimhae-Si (KR)

(72) Inventors: Gwang Seok Song, Gimhae-Si (KR); Gwang Rae Cho, Busan (KR)

(73) Assignees: HI-CO., LTD.; Gwang Seok Song; Gwang Rae Cho

(21) Appl. No.: 16/934,402

(22) Filed: Jul. 21, 2020

Related U.S. Application Data
(63) Continuation of application No. PCT/KR2019/006409, filed on May 29, 2019.

(51) Int. Cl. D06N 3/00; B32B 5/02; B32B 5/24; B32B 27/12; D06N 3/06; D06N 3/14; D06N 3/04

(52) U.S. Cl. CPC D06N 3/0063; B32B 2590/00; B32B 5/24; B32B 27/12; D06N 3/0006; D06N 3/06; D06N 3/14; D06N 3/042; B32B 2255/02; B32B 2255/26; B32B 2264/101; D06N 2203/068; D06N 2203/041; D06N 2203/048; B32B 5/024

(57) ABSTRACT

A method of manufacturing a fabric material with an embossed layer, and a fabric material manufactured thereby are provided. The method includes applying a composition containing a synthetic resin, an embossing resin, and an additive on one surface of the fabric sheet to form an embossed coating layer and drying the embossed coating layer. The fabric material is advantageous in that the embossed coating layer is securely retained on the fabric sheet, various designs giving an aesthetic impression, exhibiting a look of a specific texture and roughness, and having various patterns can be easily printed thereon, and decoration effects as interior and exterior house finishing goods can be enhanced with the use of the fabric material.

### REFERENCE TO RELATED APPLICATIONS

This is a continuation of International Patent Application PCT/KR2019/006409 filed on May 29, 2019, the content of which is incorporated herein by reference.

### FIELD OF THE INVENTION

The present invention relates to a method of manufacturing a fabric material (i.e., woven or unwoven cloth) with an embossed coating layer, and a fabric material produced thereby.

### BACKGROUND OF THE INVENTION

In general, indoor and outdoor advertisement prints and indoor and indoor and outdoor house finishing goods have been made by printing designs for advertisement, promotion, and guidance on a metal plate such as aluminum plate.

Alternatively, a metal plate is first embossed to impart a look of specific texture to an advertisement design or to prevent slippage on the metal plate, and the intended design is then printed thereon.

The embossed metal advertising plate is manufactured by coating a plate with a mixture of glass beads and an epoxy resin.

Recently, fabric materials such as non-woven fabrics have drawn attraction as printing materials for advertisement, promotion, guidance, and house finishing goods. Therefore, there has been an attempt to form an embossed design on a fabric material. However, in the case forming an embossed design on a fabric material by using a conventional method of forming an embossed design on a metal plate, there are problems in that the embossed designs formed on non-woven fabrics are easily damaged or peeled off. That is, a representation of a specific texture and an anti-slip effect cannot last long enough.

Therefore, it is required to develop a technology for manufacturing an embossed fabric to overcome this problem.

### SUMMARY OF THE INVENTION

The present invention has been made to solve the above problems, and an objective of the present invention is to provide a method of manufacturing a fabric material with an embossed coating layer by preparing a composition containing a synthetic resin, an embossing agent, and an additive, applying the composition onto a fabric sheet, and drying the applied composition to form the embossed coating layer. Another objective of the present invention is to provide a fabric material produced by the method. The fabric material produced thus is advantageous in that the embossed coating layer is securely retained on the fabric sheet, various designs giving an aesthetic impression, exhibiting a look of a specific texture or roughness, and having various patterns can be easily printed thereon, and the fabric material can enhance decoration effects as interior and exterior house finishing goods.

In addition to these objects, other objectives, features, and advantages of the present invention will be clearly understood from a description given blow. It is further noted that the claimed inventions, embodiments disclosed in the detailed description, all means and combinations that can be derived without departing therefrom fall within the scope of the invention.

In order to accomplish one objective of the invention, one aspect of the invention provides a method of manufacturing a fabric material with an embossed coating layer, the method including: a preparation process of setting a release paper sheet; a first coating process of applying an adhesive to one surface of the release paper sheet to form an adhesive coating layer; a first drying step of drying the adhesive coating layer; a transfer process of laminating the adhesive coating layer on a fabric sheet; a second coating process of forming an embossed coating layer by applying a composition containing a synthetic resin, an embossing agent, and an additive on the fabric sheet laminated with the adhesive coating layer; a second drying process of drying the embossed coating layer; and, a pattern forming process of applying an ink to a predetermined location of the dried embossed coating layer to form a pattern layer and then drying the fabric sheet. The fabric sheet may be made of either woven or non-woven cloth. The synthetic resin may include one or more kinds of resin selected from among PVC resin, urethane resin, or acrylic resin. The embossing agent may include one or more kinds of beads selected from among glass beads and silica beads. The additive may be a surfactant.

In order to accomplish another objective of the invention, another aspect of the invention provides a fabric material with an embossed coating layer, the fabric material including: a release paper sheet; an adhesive coating layer formed by coating and drying an adhesive on one surface of the release paper sheet; a fabric sheet laminated with the adhesive coating layer; an embossed coating layer formed by coating and drying a composition containing a synthetic resin, an embossing agent, and an additive on one surface of the fabric sheet; and a patterned layer formed by applying ink to a predetermined location of the embossed coating layer and drying the ink.

The inventions described above have advantages described below.

The fabric-based embossed member according to the invention is advantageous over a conventional plate-based embossed member in that when used as a printing material for advertisement, promotion, and guidance, an interior material, or an anti-slipping material, it is possible to enhance an aesthetic impression of design and pattern, exhibit a look of a specific texture and roughness, and have a decoration effect.

In addition, effects of the present invention include not only those described in the embodiments and claims but also other effects that can be derived without departing from the scope thereof and possible advantageous effects that can contribute to industrial development.

### BRIEF DESCRIPTION OF THE DRAWINGS

FIG. 1 is a flowchart illustrating a method of manufacturing a fabric material with an embossed coating layer, in accordance with a first embodiment of the invention;

FIG. 2 is a cross-sectional view illustrating the fabric material in accordance with the first embodiment of the invention;

FIG. 3 is a flowchart illustrating a method of manufacturing a fabric material with an embossed coating layer, in accordance with a second embodiment of the invention; and

FIG. 4 is a cross-sectional view illustrating the fabric material in accordance with the second embodiment of the invention.

### DETAILED DESCRIPTION OF THE INVENTION

The present invention provides a method of manufacturing a fabric material with an embossed coating layer, and a fabric material manufactured thereby, in which the fabric material is advantageous in that the embossed coating layer is securely retained, various designs giving an aesthetic impression, exhibiting a look of a specific texture and roughness, and having various patterns can be easily printed thereon, and decoration effects as interior and exterior house finishing goods can be enhanced.

The fabric material manufacturing method capable of accomplishing one objective includes: a preparation process of setting a release paper sheet; a first coating process of applying an adhesive to one surface of the release paper sheet to form an adhesive coating layer; a first drying step of drying the adhesive coating layer; a transfer process of laminating the adhesive coating layer on a fabric sheet; a second coating process of forming an embossed coating layer by applying a composition containing a synthetic resin, an embossing agent, and an additive on the fabric sheet laminated with the adhesive coating layer; a second drying process of drying the embossed coating layer; and, a pattern forming process of applying an ink to a predetermined location of the dried embossed coating layer to form a pattern layer and then drying the fabric sheet. The fabric sheet may be made of either woven or non-woven cloth. The synthetic resin may include one or more kinds of resin selected from among PVC resin, urethane resin, or acrylic resin. The embossing agent may include one or more kinds of beads selected from among glass beads and silica beads. The additive may be a surfactant.

The fabric material capable of accomplishing another objective includes: a release paper sheet; an adhesive coating layer formed by coating and drying an adhesive on one surface of the release paper sheet; a fabric sheet laminated with the adhesive coating layer; an embossed coating layer formed by coating and drying a composition containing a synthetic resin, an embossing agent, and an additive on one surface of the fabric sheet; and a patterned layer formed by applying ink to a predetermined location of the embossed coating layer and drying the ink.

The fabric-based embossed member according to the invention is advantageous over a conventional plate-based embossed member in that when used as a printing material for advertisement, promotion, and guidance, an interior material, or an anti-slipping material, it is possible to enhance an aesthetic impression of design and pattern, exhibit a look of a specific texture and surface roughness, and enhance a decoration effect.

Hereinafter, preferred embodiments of the present disclosure will be described in detail with reference to the accompanying drawings. Prior to describing the advantages and features of the present invention and the manner of achieving them will become apparent with reference to the embodiments described in detail below and the accompanying drawings. The terminology used herein is for the purpose of describing particular embodiments only and is not intended to limit the claimed invention. As used herein, the singular forms “a”, “an”, and “the” are intended to include the plural forms as well, unless the context clearly indicates otherwise. Terms and words used herein to represent directions are only for helping an understanding of embodiments and thus the terms and words used herein can be differently expressed depending on the point of view.

The present invention provides a method of manufacturing a fabric material with an embossed coating layer, and a fabric material manufactured thereby, in which the fabric material is advantageous in that the embossed coating layer is securely retained, various designs giving an aesthetic impression, exhibiting a look of a specific texture and roughness, and having various patterns can be easily printed thereon, and decoration effects as interior and exterior house finishing goods can be enhanced. The preferred embodiments embodying the present inventions will be described below.

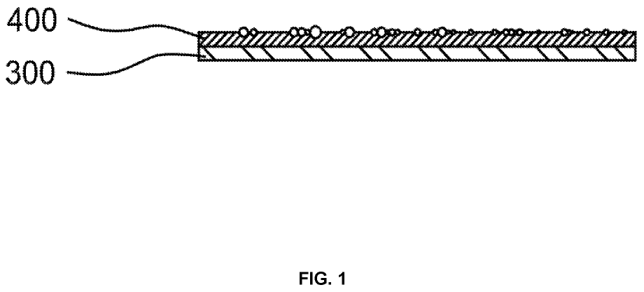

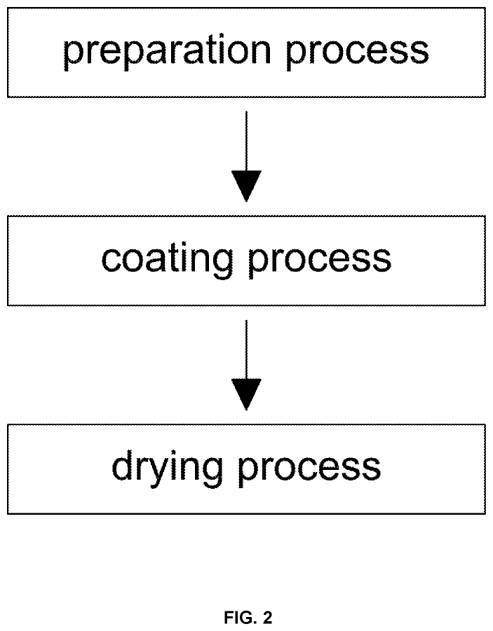

First, a method of manufacturing method a fabric material with an embossed coating layer, in accordance with a first embodiment of the invention, includes a preparation process, a coating process and a drying process as shown in FIGS. 1 to 2.

The preparation process is a process of setting a roll of fabric 300, such as woven or non-woven cloth, is put on an unwinder so that the fabric 300 can be unwound.

The coating process is a process of forming an embossed coating layer 400 by applying a specific composition on one surface of the fabric 300 using by the comma coating method. The specific composition is a mixture of a synthetic resin, an embossing agent, and an additive.

Here, the synthetic resin includes one or more kinds of resin selected from among PVC resin, urethane resin, and acrylic resin. In addition, the embossing agent is composed of one or more kinds of beads selected from among glass beads and silica beads. The additive is a surfactant.

The composition in which the synthetic resin, the embossing agent, and the additive are mixed is capable of forming an embossed surface or anti-slipping surface. The composition can be coated and printed by a printer such as a solvent printing machine, a latex printing machine, a UV printing machine, and an offset printing machine. When the composition is printed, it has an waterproofing property so that ink is difficult to erase.

Subsequently, the drying process is a process of drying the embossed coating layer 400 with hot air with a temperature in a predetermined range in the chamber, thereby producing a composite (hereinafter, referred to as embossed fabric for convenience of description) of the fabric and the embossed coating layer.

In addition, after the drying process, the surfaces of the fabric 300 and the embossed coating layer 400 are inspected, and then the inspected fabric 300 is wound by a rewinder.

After the drying process, a pattern forming process may be performed.

The pattern forming process is a process of applying ink that is prepared by mixing oil, water, organic pigment, or inorganic pigment with resin to a predetermined location on the surface of the embossed coating layer and drying the ink, thereby forming a pattern layer.

By forming the pattern layer on the embossed coating layer, the combination of the pattern layer and the embossed coating layer has the advantage of further enhancing a decoration effect by imparting an aesthetic impression, a look of a specific texture, and/or a pattern to a fabric material.

Next, a method of manufacturing a fabric material with an embossed coating layer, in accordance with a second embodiment of the invention will be described. (In describing the second embodiment, a description of components, steps, or processes the same as those in the first embodiment will be omitted.)

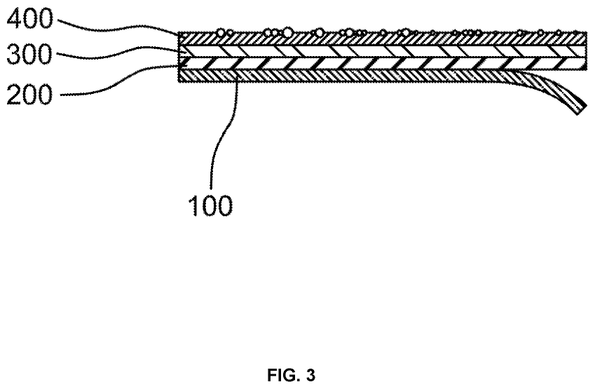

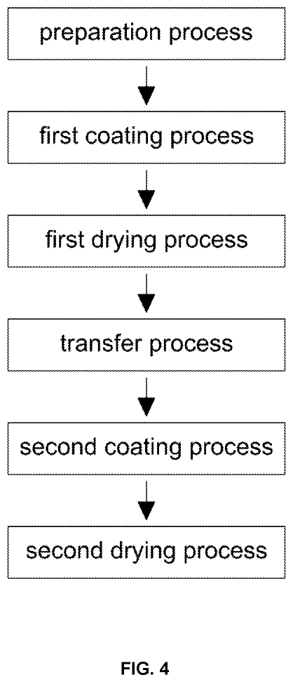

As illustrated in FIGS. 3 and 4, the second embodiment is to produce a fabric material with an embossed coating layer to which a release paper sheet is attached. After detaching the release paper sheet, the fabric material can be pasted on an intended surface. The method in accordance with the second embodiment includes a preparation step, a first coating process, a first drying process, a transfer process, a second coating process, and a second drying process.

The preparation process is a process of setting a roll of release paper 100 on an unwinder so that a surface of the release paper 100 is coated while the release paper is unwound.

The first coating process is a process of forming an adhesive coating layer 200 on one surface of the release paper by applying an adhesive to the one surface of the release paper by using the comma coating method.

The first drying process is a process of drying the adhesive coating layer 200 in a chamber with hot air of a temperature within a predetermined range.

The transfer process is a process of laminating the adhesive coating layer 200 on one surface of fabric 300. The adhesive coating layer 200 is laminated on the fabric 300 with the use of a press roller while the fabric 300 is unwound by another unwinder. After such a transfer process, surface inspection is performed on the resulting fabric laminate and the fabric laminate 300 is wound.

The second coting process and the second drying process in the second embodiment are the same as the coating process and the drying process in the first embodiment, respectively. Therefore, a description of the second coating process and the second drying process will be omitted.

Due to the second drying process, the fabric laminate and the embossed coating layer are securely bonded to produce a fabric material with an embossed coating layer. Next, the surfaces of the fabric laminate 300 and the embossed coating layer 400 are inspected, and the fabric laminate 300 with the embossed coating layer 400 is wound by using a rewinder.

The embodiments that have been described herein above are merely illustrative of the technical idea of the present invention, and thus various modifications, changes, alterations, substitutions, subtractions, and additions may also be made by those skilled in the art without departing from the gist of the present invention. The embodiments disclosed in the present specification and the accompanying drawings are provided only for illustrative purposes and are not intended to limit the spirit of the present invention. The scope and the technical spirit of the present invention should not be construed as being limited to the embodiments and the drawings. The protection scope of the present invention should be construed as defined in the following claims, and it is apparent that all technical ideas equivalent thereto fall within the scope of the present invention.

As compared with plate-based members in the related art, the fabric-based embossed member in accordance with the invention can be popularly used as a printing material for advertisement, promotion, and guidance, an interior material, or an anti-slipping material. In addition, since the fabric-based embossed member can enhance an aesthetic impression of design and pattern, exhibit a look of a specific texture and roughness, and enhance a decoration effect, the demand for the fabric-based embossed member is expected to increase in design businesses.

What is claimed is:

1. A method of manufacturing a fabric material with an embossed coating layer, the method comprising:
a preparation process of setting a release paper sheet;
a first coating process of forming an adhesive coating layer by applying an adhesive on one surface of the release paper sheet;
a first drying process of drying the adhesive coating layer;
a transfer process of laminating the adhesive coating layer on a fabric sheet;
a second coating process of forming an embossed coating layer on the fabric sheet laminated with the adhesive coating layer by applying a specific composition containing a synthetic resin, an embossing agent, and an additive to the fabric sheet;
a second drying process of drying the embossed coating layer; and
a pattern forming process of forming a pattern layer by applying ink at a predetermined location on the dried embossed coating layer and by drying the pattern layer,
wherein the fabric sheet is made of woven or unwoven cloth;
the synthetic resin comprises one or more kinds of resin selected from among PVC resin, urethane resin, and acrylic resin,
the embossing agent comprises one or more kinds of beads selected from among glass beads and silica beads, and
the additive comprises a surfactant.

2. A fabric material with an embossed coating layer, the fabric material comprising:
a release paper sheet;
an adhesive coating layer formed on one surface of the release paper sheet by applying an adhesive on the surface of the release paper sheet and drying the adhesive;
a fabric sheet laminated with the adhesive coating layer;
an embossed coating layer formed on one surface of the fabric sheet by applying a composition containing a synthetic resin, an embossing agent, and an additive on the surface of the fabric sheet and drying the composition; and
a pattern layer formed by applying an ink onto a predetermined location on the embossed coating layer and drying the ink.
